(19) United States
(12) Patent Application Publication
(10) Pub. No.: US 2002/0082987 A1
(43) Pub. Date: Jun. 27, 2002

(54) Systems and methods for making installment loan payments using payroll debits

(76) Inventor: Linda S. Wilson, Berlin, NJ (US)

Correspondence Address: Peter H. Priest, Law offices of Peter H. Priest, 529 Dogwood Drive, Chapel Hill, NC, 27516, US

(21) Appl. No.: 09/748,935

(22) Filed: Dec. 27, 2000

(51) Int. Cl. G06F 17/60

(52) U.S. Cl. 705/39

(57) ABSTRACT

Systems and techniques are described for the payment of installment debts by providing functionality to automatically debit the amount from the consumer's payroll check. One technique includes deducting amounts from a consumer's paycheck according to the employee's authorizations, forwarding the deducted amounts to a financial intermediary to be held in a custodial account, establishing send dates for each installment payment due, and monitoring the send dates for all payments to determine whether a payment is to be sent to the creditor. If a payment is to be sent to the creditor, it is determined whether there are sufficient funds in the custodial account to make the payment, and, if there are sufficient funds in the custodial account to make the payment, the payment is forwarded to the creditor.

### BACKGROUND OF THE INVENTION

1. Field of the Invention

The present invention relates generally to improvements to systems and methods for making installment loan payments, and more particularly to advantageous aspects of systems and methods for making installment payments using payroll debits.

2. Description of the Prior Art

In today's credit-based economy, consumers commonly enter into long-term loans or other financing arrangements for major expenditures, such as houses, cars, and higher education. In addition, consumers commonly receive income in the form of paychecks, which are typically received from employers every week, every two weeks, or twice a month. In managing their monthly cash flow, consumers typically deposit their paychecks into a checking account and, at the appropriate days each month, write a check against the deposited funds to make the required monthly installment payments. Systems have been developed that allow consumers to make installment payments automatically or semi-automatically. However, as described in further detail below, these systems have a number of disadvantages.

### SUMMARY OF THE INVENTION

One aspect of the present invention provides systems and methods for the payment of installment debts by providing functionality to automatically debit the amount from the consumer's payroll check. A method according to a further aspect of the invention includes the steps of deducting amounts from a consumer's paycheck according to the employee's authorizations, forwarding the deducted amounts to a financial intermediary to be held in a custodial account, establishing send dates for each installment payment due, and monitoring the send dates for all payments to determine whether a payment is to be sent to the creditor. If a payment is to be sent to the creditor, it is determined whether there are sufficient funds in the custodial account to make the payment, and, if there are sufficient funds in the custodial account to make the payment, the payment is forwarded to the creditor.

Additional features and advantages of the present invention will become apparent by reference to the following detailed description and accompanying drawings.

### BRIEF DESCRIPTION OF THE DRAWINGS

FIG. 1 shows a diagram of a process for setting up an electronic payment system.

FIG. 2 shows a diagram of a process for making installment payments using the electronic payment system set up in FIG. 1.

FIG. 3 shows a diagram of a process for setting up an automated clearinghouse payment system.

FIG. 4 shows a diagram of a process for making installment payments using the automated clearinghouse payment system set up in FIG. 3.

FIG. 5 shows a diagram of a payroll debit system according to a first aspect of the present invention.

FIG. 6 shows a diagram of a process for setting up the payroll debit system illustrated in FIG. 5.

FIG. 7 shows a diagram of a process for making a payroll deduction using the system illustrated in FIG. 5.

FIG. 8 shows a diagram of a process for making an installment payment using the system illustrated in FIG. 5.

### DETAILED DESCRIPTION

In order to make large purchases, a consumer commonly borrows money from a bank or other financial institution, and then retires the loan through monthly installment payments. A typical consumer receives income in the form of paychecks that are received every week, every two weeks, or twice a month. The consumer typically deposits the paychecks into a checking account, and then uses the accumulated funds to make the required installment payments as they become due each month.

This process has traditionally been conducted using paper-based transactions. Consumers typically receive paper checks either in person or by mail, and then deposit those paychecks into their checking accounts, again either in person or by mail. Then, at the appropriate times each month, consumers write out a check that is mailed or otherwise delivered to the creditor to make the required installment payment. The paper-based approach for making installment payments has a number of disadvantages. First, it requires consumers to monitor the date upon which installment payments are due, write a check out to the creditor, and then mail the check so that it arrives before the due date. A second disadvantage is psychological. Installment payments can represent a rather large portion of a typical consumer's income. Thus, wage earners may have unrealistic perceptions of how much money they have prior to making installment payments and, when installment payments become due, may view the payments as being unduly onerous.

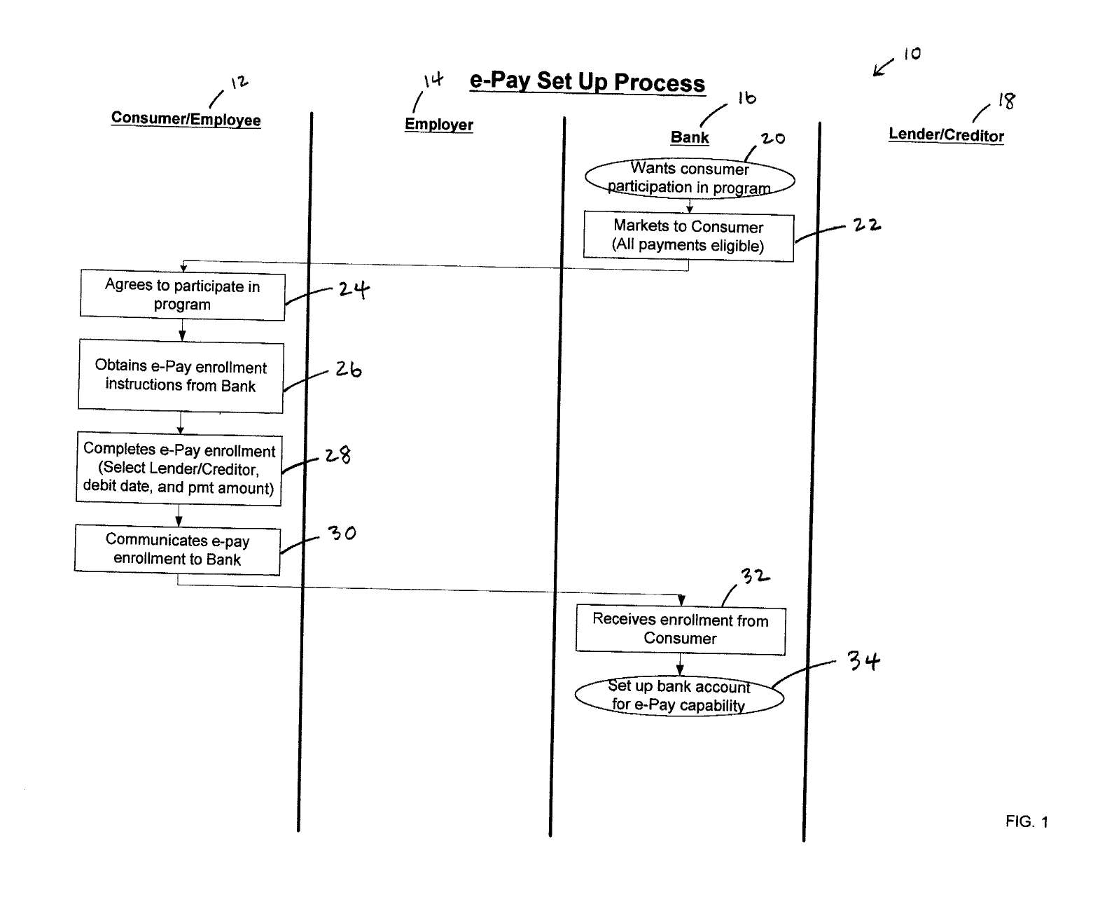

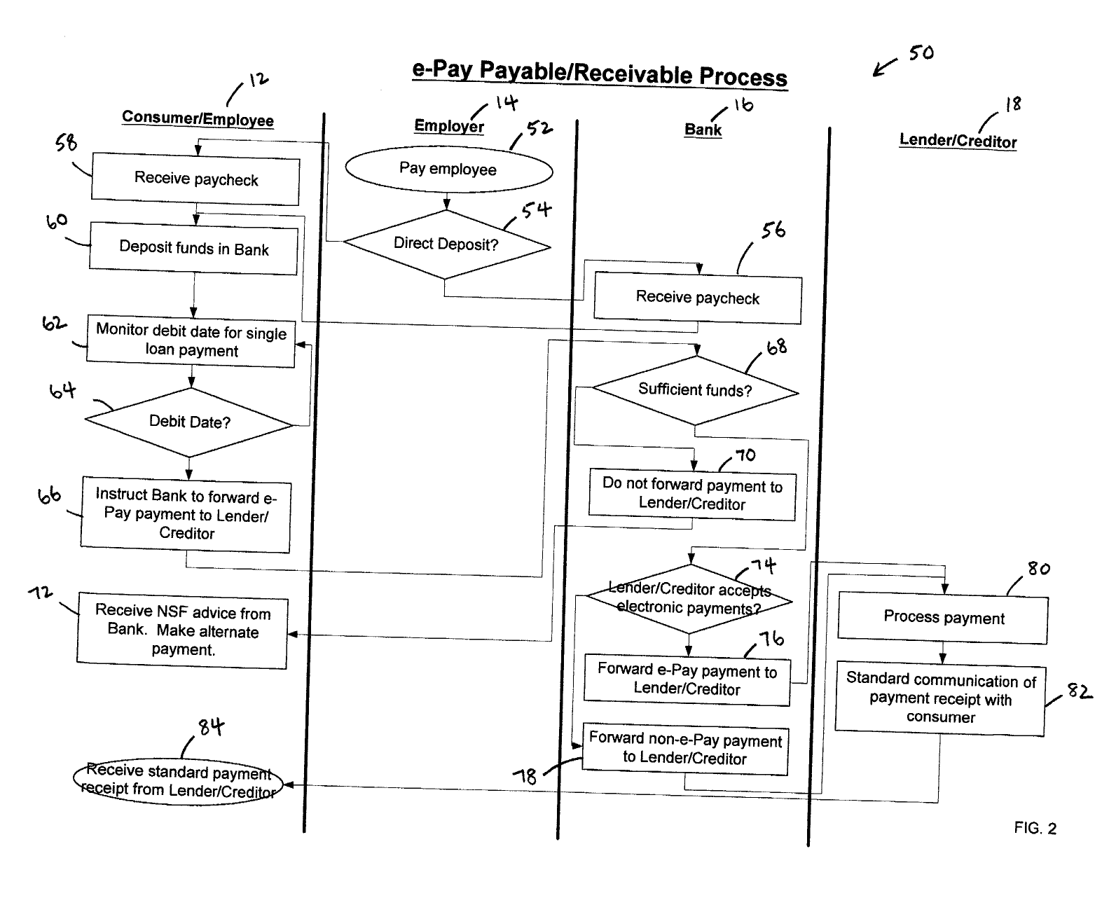

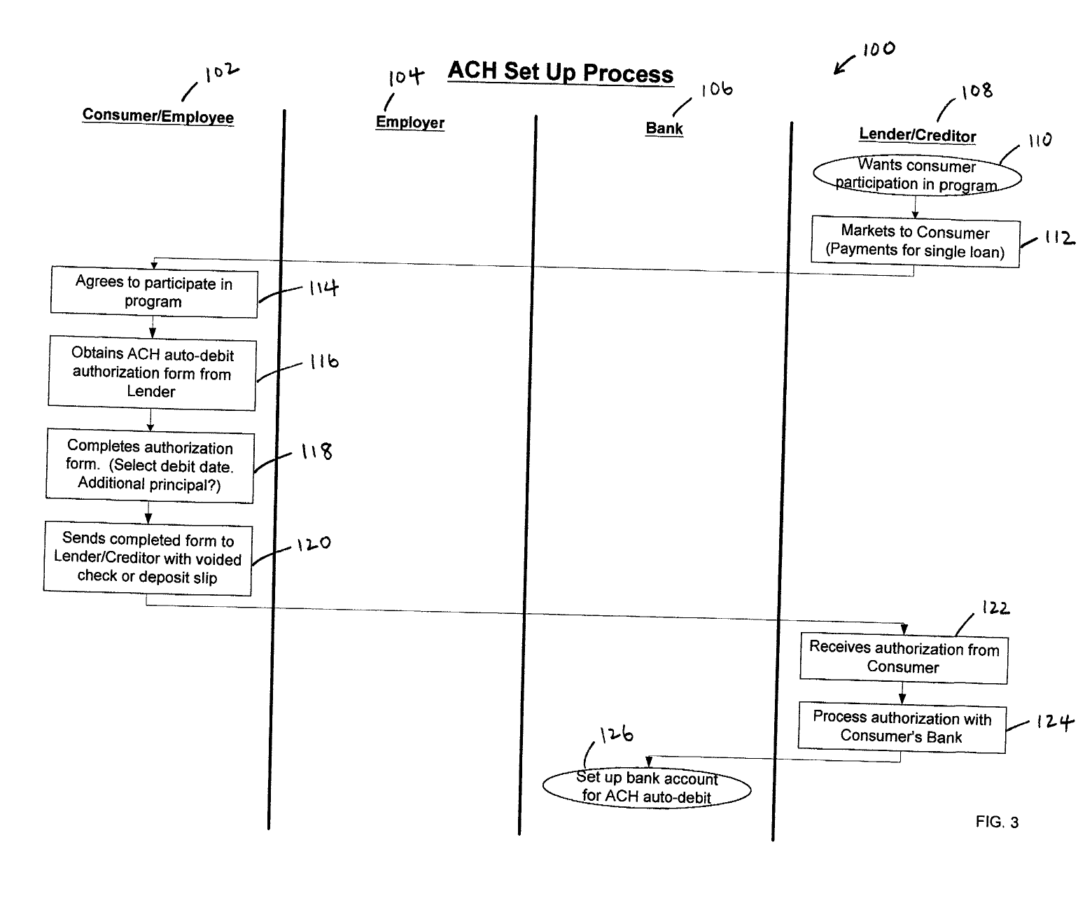

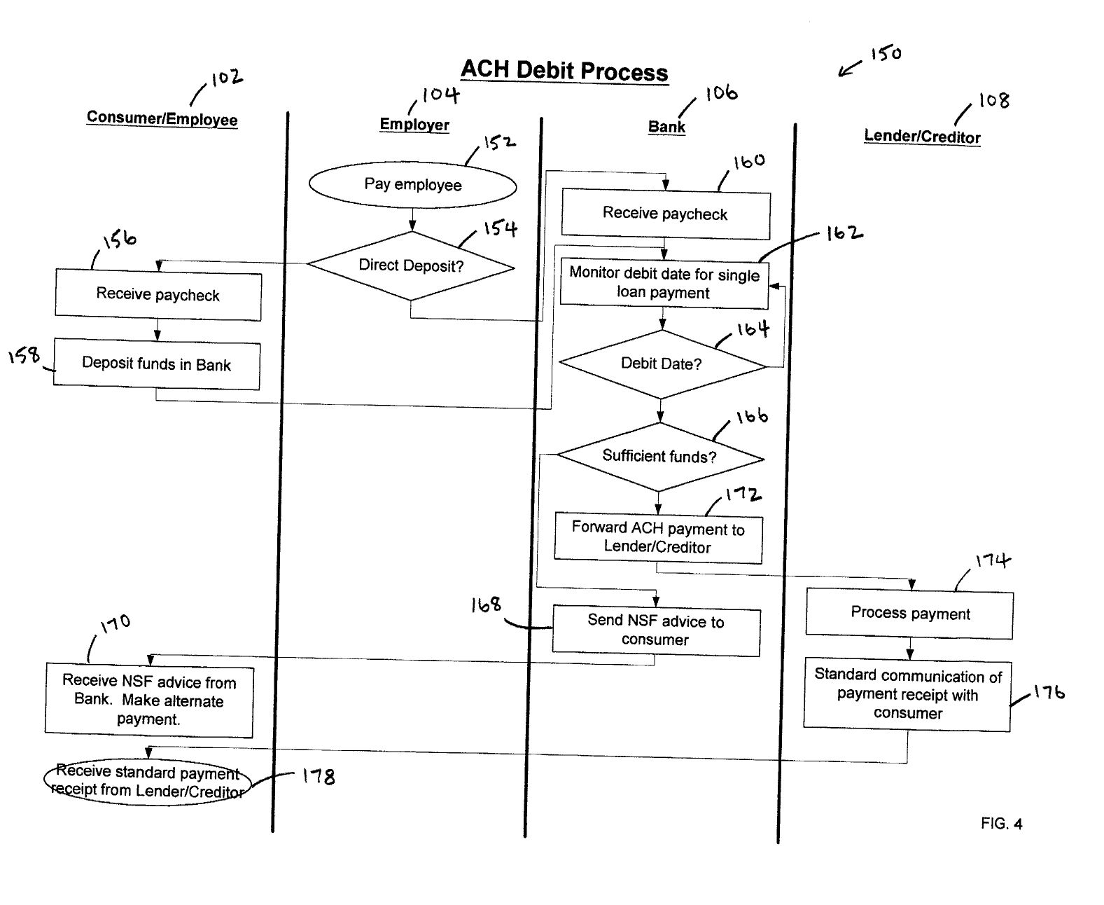

A number of systems have been developed to make the installment payment process automatic, or semi-automatic, and to use electronic payments rather than paper-based payments. First, many employers offer as a benefit to their employees direct deposit of their paychecks. This arrangement saves employees a trip to the bank and also ensures that the funds will become available to the employee as soon as possible. Beyond direct deposit, systems have been developed for making installment payments automatically or semi-automatically. One semi-automatic system currently in use is an “electronic payment” (e-pay) system, illustrated in FIGS. 1 and 2. One automatic system currently in use is an “automated clearinghouse” (ACH) system, illustrated in FIGS. 3 and 4. Both systems are described below.

FIGS. 1 and 2 show diagrams illustrating an exemplary e-pay system, in which consumers electronically place an order to their financial institutions to make required installment payments. FIG. 1 shows a diagram of the process used to set up the exemplary e-pay system for an individual consumer, and FIG. 2 shows a diagram of the process for using the e-pay system to make payments to the lender or creditor.

As shown in FIG. 1, which illustrates the e-pay system setup process 10, there are four entities involved in the e-pay system: a consumer/employee 12 (hereinafter referred to as a “consumer”), the consumer's employer 14, the consumer's bank 16, and the consumer's lender/creditor 18 (hereinafter referred to as a “creditor”), to whom the installment payments are to be made. In step 20, the bank 16 decides that it desires consumer participation in the e-pay program. In step 22, the bank markets the program to consumers. In step 24, the consumer agrees to participate in the program and in step 26 obtains e-pay enrollment instruction from the bank 16. In step 28, the consumer completes the e-pay enrollment. The enrollment process typically includes selecting the creditor, the debit date, and the amount of the installment payment. In step 30, the consumer communicates the e-pay enrollment to the bank 16. In step 32, the bank receives the enrollment from the consumer, and in step 34, the bank 16 sets up an account for the e-pay capability.

FIG. 2 sets forth the process 50 used to make installment payments in an e-pay system. In step 52, the employer 14 pays the consumer 12. As illustrated in step 54, if the payment is made by direct deposit, then in step 56, the bank 16 receives the direct deposit. Otherwise, in step 58, the consumer 12 receives the paycheck and in step 60 deposits the funds at the bank 16. In step 62, the consumer monitors the debit date for the installment payment. In step 64, it is determined whether the debit date has arrived. If the debit date has in fact arrived, then in step 66, the consumer 12 instructs the bank 16 to forward an e-pay payment to the creditor 18. In step 68, the bank 16 determines whether there are sufficient funds to make the installment payment. If not, then in step 70, the determination is made not to forward payment to the creditor, and in step 72, the consumer 12 receives an insufficient funds (NSF) notice from the bank 16.

If in step 68 is determined that there are sufficient funds to make the payment, then in step 74, it is ascertained whether the creditor 18 accepts electronic payments. If so, then in step 76 an e-Pay payment is forwarded to the creditor 18. If not, then in step 78 a non-electronic payment is forwarded to the creditor 18. In either event, in step 80, the creditor 18 process the payment, and in step 82, the creditor 18 prepares a standard communication of payment receipt. In step 84, this receipt is received by the consumer 12.

FIGS. 3 and 4 are diagrams illustrating an exemplary automated clearinghouse (“ACH”) system, in which payments are automatically deducted from the wage earner's checking account and transferred electronically to the creditor or lender. FIG. 3 shows a diagram of the process 100 of setting up an ACH system for an individual consumer, and FIG. 4 shows a diagram of the process 150 of making payments to the creditor 18 using the ACH system.

Similar to the e-pay system illustrated in FIGS. 1 and 2 discussed above, the ACH system includes four entities: a consumer/employee 102 (again referred to herein simply as the “consumer”), the consumer's employer 104, the consumer's bank 106, and the consumer's lender/creditor (referred to herein simply as the “creditor”), to whom the monthly installment payments are to be made. As shown in FIG. 3, participation in the ACH system or program is commonly initiated by the creditor 108. In step 110, the creditor 108 makes a determination that it wants consumer participation in the program. In step 112, the creditor 108 markets the program to the consumer 102. In step 114, the consumer 102 agrees to participate in the program. In step 116, the consumer 102 obtains an ACH auto-debit authorization form from the creditor 108. In step 118, the consumer 102 completes the authorization form. In step 120, the consumer 102 sends the completed form to the creditor 108 with a voided check or deposit slip. In step 122, the creditor 108 receives the authorization from the consumer 102, and in step 124, the creditor 108 processes the authorization with the consumer's bank 106. In step 126, the consumer's bank 106 sets up the bank account for ACH auto-debit.

FIG. 4 shows a typical ACH debit process 150. In step 152, the employer 104 pays the consumer 102. As illustrated in step 154, if the payment is not made by direct deposit (i.e., if it is made by a paper check), then in step 156, the consumer 102 receives the paycheck and in step 158, the consumer 102 deposits the funds in the bank. If the payment is made by direct deposit, then in step 160, the bank 106 receives the direct deposit. In both situations, the process then goes to step 162, in which the bank 106 monitors the calendar for the debit date. In step 164, it is determined whether a debit date has arrived. If it has, then in step 166, the determination is made whether there are sufficient funds in the consumer's account to make the required payment. If there are insufficient funds, then in step 168, an NSF notice is sent to the consumer. In step 170, the consumer 102 receives the NSF advice from the bank and makes arrangements for an alternative payment.

If in step 166 it is determined that there are sufficient funds to make the required payment, then in step 172, an ACH payment is forwarded to the creditor 108. In step 174, the creditor 108 processes the payment, and in step 176, the creditor 108 makes a standard communication of payment receipt. Finally, in step 178, the consumer 102 receives the standard payment receipt from the creditor 108.

The exemplary systems illustrated in FIGS. 1 through 4 and described above have a number of disadvantages. One disadvantage is psychological. In particular, in an e-pay system or an ACH system, typical consumers may develop unrealistic perceptions of how much money is available to them upon receipt of their paychecks, and may view monthly installment payments as being unduly burdensome. These perceptions, in turn, may lead to consumers spending beyond their means and falling behind or even defaulting on their loans.

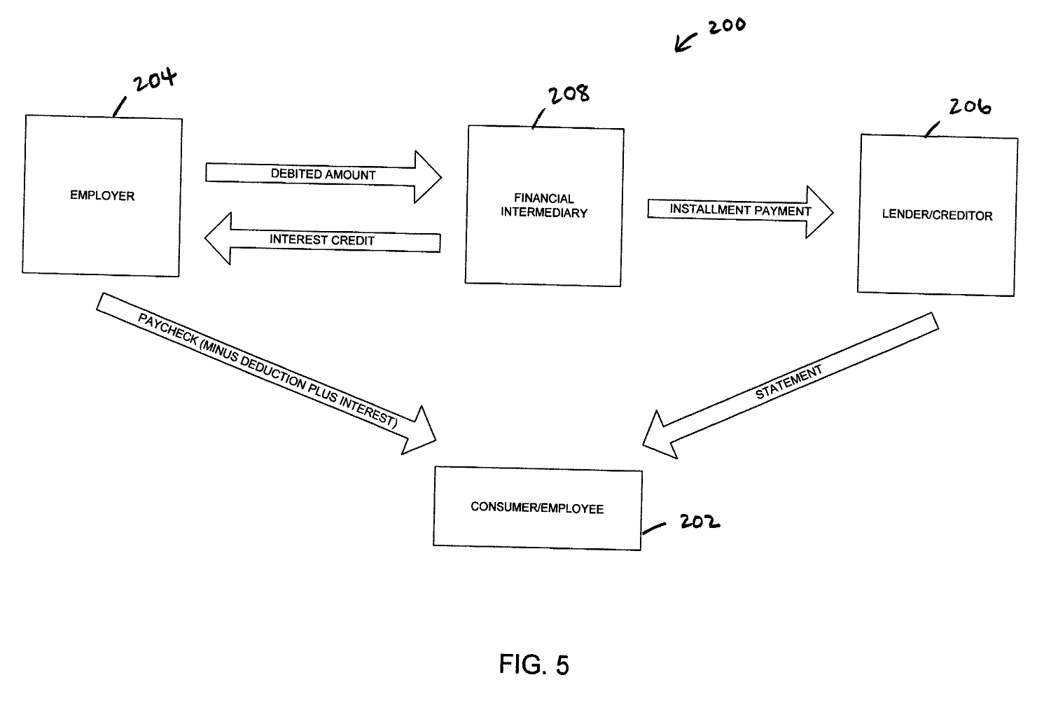

These and other issues of the prior art are addressed by the present invention, a first aspect of which provides a system for the payment of installment debts, or other regular payments, by providing functionality to automatically debit the amount of the payment from the consumer's payroll check. From the consumer's perspective, the deduction appears on their paystub like any other after-tax deduction. FIG. 5 shows a diagram of a system 200 according to a first aspect of the present invention. There are four basic participating entities in the system 200, including a consumer/employee (referred to herein simply as the “consumer”) 202, the consumer's employer 204, the consumer's lender/creditor 206 (referred to herein simply as the “creditor”), and a financial intermediary 208.

The role of the financial intermediary 208 is significantly different from the role of the bank in the e-pay and ACH systems. According to the present aspect of the invention, the financial intermediary 208 is “invisible” to the consumer/employee 202. All the consumer 202 sees is a paycheck from the employer 204, from which an amount has been deducted to be applied towards an installment payment. In addition, the consumer 202 will continue to receive any statements normally generated by the creditor in the administration of the loan.

One advantage of the present invention is that it saves the consumer's time. The consumer no longer has to expend any effort in making an installment payment. Beyond this benefit, it will be appreciated that another advantage of the present invention is psychological. As mentioned above, in prior systems, the consumer receives a paycheck and deposits it into a checking account. The consumer then makes the installment payment out of that checking account. A mortgage or other installment loan payment can represent a significant portion of a consumer's monthly outlays. Thus, a consumer may have an inflated perception of how much income they have received and may also feel unduly burdened by making the installment payment. In a system according to the present invention, the installment payment is deducted from the paycheck. Thus, typical consumers may develop more realistic perceptions as to their current monetary situation and not be tempted to spend money that should be earmarked to pay installment obligations.

Also, consumers are typically paid every week, every two weeks, or on a bimonthly basis, whereas installment payments are typically due once a month. According to a further aspect of the present invention, the amount of the installment payment is evenly divided among the consumer's paychecks. This, too, has a psychological benefit, because the monthly installment payment is broken down into smaller, more manageable portions. The present invention is also beneficial to creditors and lenders because it significantly reduces losses and collection expenses. These cost savings could then be used to offset loan origination pricing.

As illustrated in FIG. 5, the financial intermediary 208 coordinates the flow of payments between the employer 204 and the creditor 206. The employer 204 forwards all debited funds to the financial intermediary 208. If the creditor 206 accepts multiple or partial payments, the financial intermediary 208 forwards the debited funds directly to the creditor 206. If, however, the creditor 206 requires a single monthly payment, the financial intermediary 208 accumulates the payments on behalf of the consumer 202 and then forwards the accumulated payments to the lender/creditor 206 when a full payment has been accumulated. In this second scenario, some or all of the interest earned by the financial intermediary 208 is passed onto the consumer 202 in the form of a credit back to the employer 204, which is then added back to the employee's paycheck.

It should be noted that although the present discussion is directed to monthly installment payments, the present invention is also applicable to payments that are made less frequency, such as on a quarterly or biannual basis. The present system can be used to divide such payments into equal portions to be deducted by the consumer's paycheck. It should also be noted that because the financial intermediary is accumulating payroll deductions for a large number of consumers, it may be able to offer higher interest payments on the “float” than individual consumers would be able to obtain for themselves.

It should also be noted that because the financial intermediary is accumulating payroll deductions for many consumers, the division of the installment payment can be spread among multiple participants who mutually share in the obligation. For example, an installment payment could be split between a husband and wife, so long as both were participants in a system according to the present invention. In this example, both the husband and wife's paychecks would be debited, and the debited funds accumulated and paid to a creditor/lender as described herein.

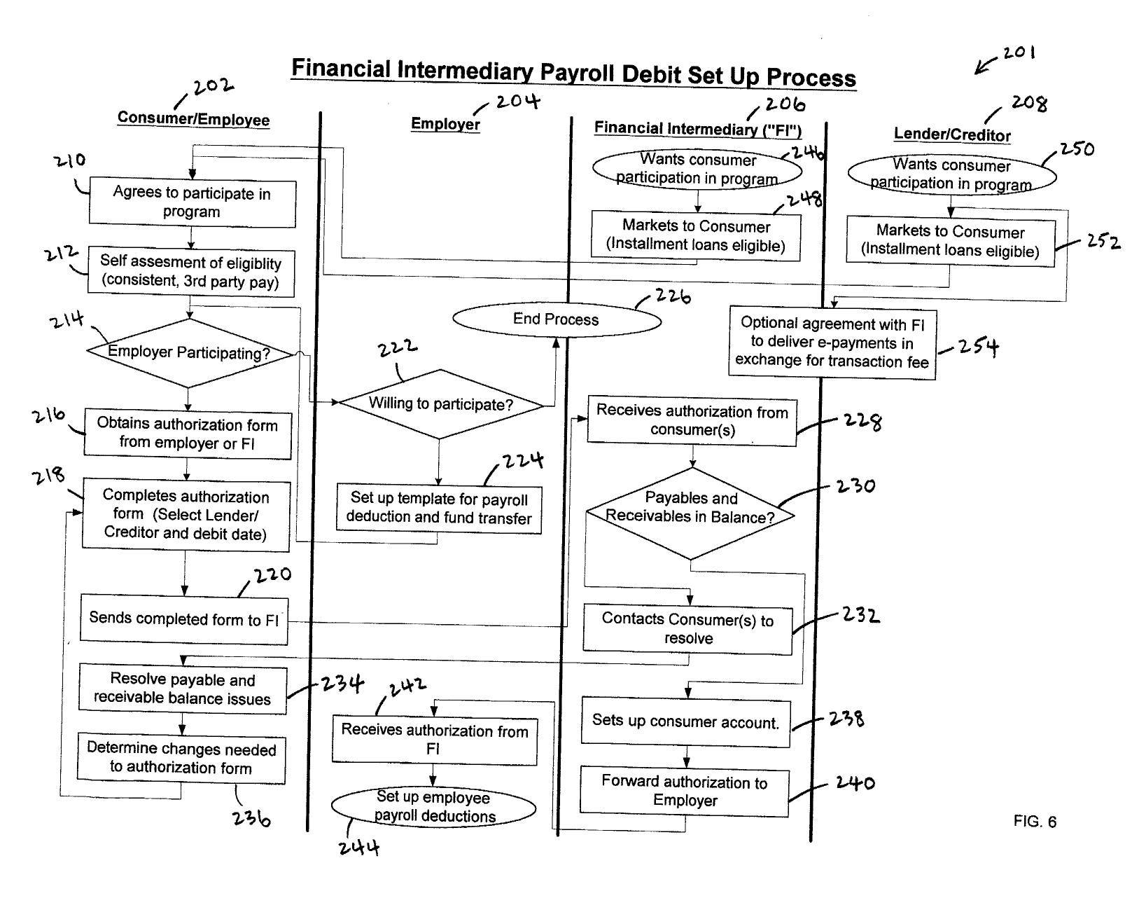

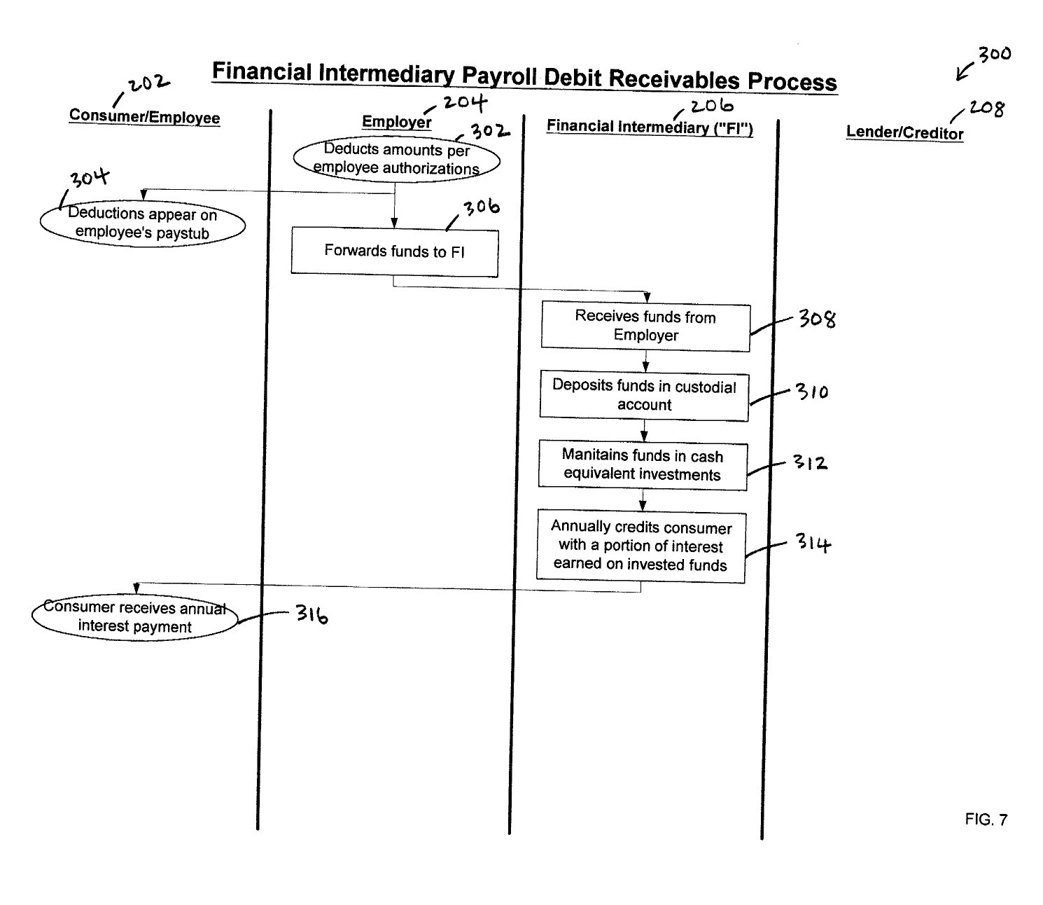

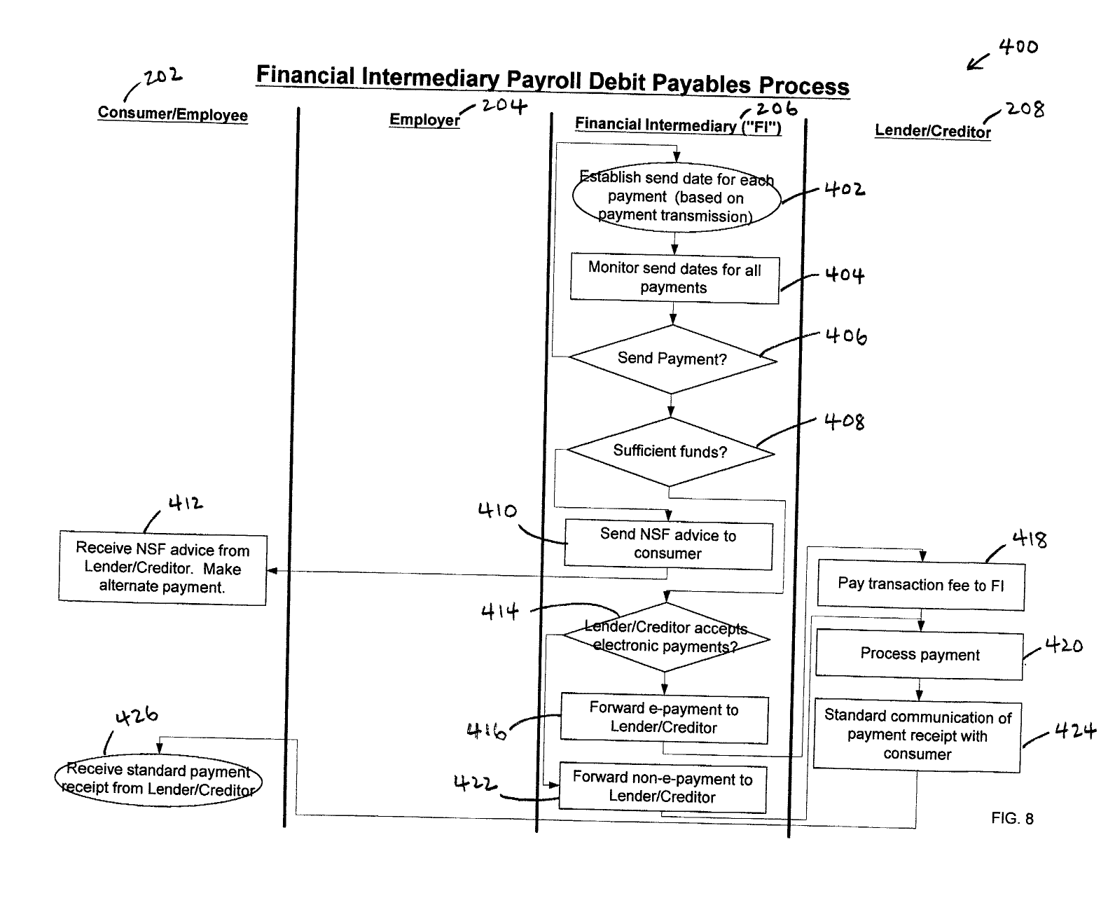

The present embodiment of the invention includes three components. The first component, illustrated in FIG. 6, is a payroll debit setup process 201, which is used to set up the payroll debit system for a new user. The second component, illustrated in FIG. 7, is a payroll debit receivables process 300, which is the process used to transfer funds that have been debited by an employer from a paycheck to a financial intermediary. The third component, illustrated in FIG. 8, is a payroll debit payables process 400, which is the process used to transfer funds from the financial intermediary to the employee's creditor. Each of these components are discussed in detail below.

FIG. 6 is a diagram of the payroll debit setup process 201. In step 210, the consumer 202 agrees to participate in the program. In step 212, the consumer 202 performs a self assessment of his or her eligibility to participate in the program. One mandatory prerequisite for participation in the program is a consistent stream of payments from a third party, typically an employer.

In step 214, it is determined whether the consumer's employer is already a participant in the program. If the employer is already a participant, then in step 216, the consumer obtains an authorization form from the employer 204 or, if desired, from the financial intermediary 206. In step 218, the consumer 202 completes the authorization form. The form includes an identification of the creditor 208, the amount of the monthly installment payment due, and the debit date for the installment payment. In step 220, the completed form is forwarded to the financial intermediary 206.

If, in step 214, it is determined that the employer 204 is not currently a participant in the program, then in step 222, an inquiry is made to the employer to determine whether the employer is willing to become a participant. If the employer is willing, then in step 224, the employer works with the financial intermediary 206 to set up a template for payroll deduction and fund transfer. The process then returns to step 214. However, if in step 222 it is determined that the employer is not willing to participate, then in step 226 the process is terminated.

Returning to step 220, the completed authorization form is sent to the financial intermediary. In step 228, the form is received by the financial intermediary 206. In step 230, the financial intermediary 206 analyzes the authorization form to determine whether the payables and receivables are in balance. In particular, the financial intermediary 206 determines whether the employee has an income stream that is sufficient to support the installment payments to be made by the financial intermediary. If the payables and receivables are not in balance, then in step 232, the customer is contacted to resolve the issue.

In steps 234 and 236, the consumer 202 resolves the payables and receivables issues, and determines changes needed to be made to the authorization form. The process then returns to step 218, in which the consumer 202 completes the authorization form incorporating the necessary changes, and in step 220, the revised form is sent to the financial intermediary 206. In step 238, the financial intermediary 206 sets up the consumer account 238, and in step 240, a suitable authorization is forwarded to the employer 204, authorizing the debit of funds from the consumer's paycheck. In step 240, the employer 204 receives authorization from the financial intermediary, and in step 242, the employer 204 sets up the payroll deductions.

As further illustrated in step 246, the financial intermediary 206 may independently want to seek out consumer participation in the program. Thus, in step 248, the financial intermediary can market to consumers, particularly to those consumers that are eligible for installment loans. Similarly, as illustrated in step 250, the creditor 208 may also wish to encourage participation by consumers in the program. Thus, in step 252, the creditor 208 can market to consumers 202, particularly to those consumers that are eligible for installment loans. In either case, the process then returns to step 210, in which the consumer/employee agrees to participate in the program. Also, as shown in step 254, the creditor 208 can enter into an optional agreement with the financial intermediary 206 to deliver e-payments in exchange for a transaction fee.

FIG. 7 shows a diagram of the payroll debit receivables process 300 that is used to deduct funds from the consumer's paycheck. In step 302, the employer 204 deducts the appropriate amount from the employee's paycheck according to the employee's prior authorizations. As mentioned above, it is contemplated that an employee will typically wish to divide the amount of the installment payment into equal portions that are deducted from every paycheck although, of course, the system may be readily modified to accommodate different deduction schedules, as desired. In step 304, the consumer 202 receives a paystub that reflects the amount of the payroll deduction. In step 306, the debited funds are forwarded to the financial intermediary 206.

In step 308, the financial 206 intermediary receives the debited funds from the employer 204. Assuming that the funds cannot be forwarded directly to the creditor 202, then in step 310, the funds are deposited in a custodial account. In step 312, the funds in the custodial account are maintained in cash equivalent investments. In step 314, the financial intermediary 206 annually credits the consumer with a portion of interest earned on the invested funds. Of course, it would also be possible for the financial intermediary to provide interest credits for other periods, such as quarterly or even monthly. In step 316, the consumer receives the annual interest payment from the financial intermediary. This can be done by direct payment from the financial intermediary to the consumer. Alternatively, the interest payment can simply be added to the consumer's paycheck.

FIG. 8 shows a diagram of the payroll debit payables process 400 that is used to transfer funds from the financial intermediary 206 to the creditor 208 in making installment payments on behalf of the consumer 202. In step 402, the financial intermediary establishes the send date for each payment, that is the date upon which the financial intermediary must transmit payment to the creditor 208 in order for the installment payment to be timely. In step 404, the financial intermediary 206 monitors send dates for all payments. In step 406, the financial intermediary 206 determines whether or not to send a payment. If not, the system returns to steps 402 and 404 to continue to establish and monitor send dates.

If in step 406 it is determined that a payment is to be sent, then in step 408, the financial intermediary determines whether there are sufficient funds in the consumer/employee's account to make the payment. If it is determined that there are insufficient funds (“NSF”), then in step 410 an NSF notice is sent to the consumer. In step 214, the consumer 202 receives the NSF notice and now must make alternate arrangements for making the installment payment.

If in step 408, the financial intermediary 206 determines that there are sufficient funds in the consumer's account to make the required payment, then in step 414, the financial intermediary 206 determines whether the creditor 208 accepts electronic payments. If the creditor in fact accepts electronic payments, then in step 416, an electronic payment is forwarded to the creditor 208. In step 418, the creditor pays a transaction fee to the financial intermediary 206, and in step 420, the installment payment is processed. If in step 414 it is determined that the creditor does not accept electronic payments, then in step 422, a non-electronic payment, such as a paper check, is forwarded to the creditor 206, and in step 420, the installment payment is processed. In step 424, the creditor prepares a standard communication of payment receipt with the consumer, and in step 426, the consumer receives the standard payment receipt from the creditor.

It will be apparent that numerous modifications can be made to the systems described above without departing from the spirit of the invention. For example, although the system as described herein contemplates the deduction of funds from a paycheck by an employer, other types of regular payments may also be the source of deducted funds. In addition, although the system as described herein contemplates the making of installment payments to retire a loan, other types of regular payments may also be made using the described system.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

I claim:

1. A method for making installment payments to a creditor, comprising:
(a) deducting amounts from a consumer's paycheck according to the employee's authorizations;
(b) forwarding the deducted amounts to a financial intermediary to be held in a custodial account;
(c) establishing send dates for each installment payment due;
(d) monitoring the send dates for all payments to determine whether a payment is to be sent to the creditor;
(e) if a payment is to be sent to the creditor, determining whether there are sufficient funds in the custodial account to make the payment; and
(f) if there are sufficient funds in the custodial account to make the payment, forwarding payment to the creditor.

2. The method of claim 1, wherein step (a) includes indicating the amounts deducted from the consumer's paycheck on a paystub.

3. The method of claim 1, wherein step (b) including maintaining the funds in the custodial account in cash equivalent instruments.

4. The method of claim 3, wherein step (b) including annually crediting the consumer with a portion of interest earned on the funds in the custodial account.

5. The method of claim 1, wherein in step (e), if it determined that there are not sufficient funds to make a payment to the creditor, the following step is performed:
sending a notice of insufficient funds to the consumer.

6. The method of claim 1, wherein step (f) includes determining whether the creditor accepts electronic payments and, if so, forwarding an electronic payment to the creditor.

7. The method of claim 6, wherein if it determined that the creditor does not accept electronic payments, step (f) includes forwarding a non-electronic payment to the creditor.

8. The method of claim 1, further including the following step (g):
(g) providing the consumer with a standard communication of payment receipt from the creditor.

9. A method for setting up a system for using payroll debits to make installment payments, comprising:
(a) performing an assessment of eligibility of a consumer to participate in the payment system;
(b) determining whether the consumer's employer is a participant in the system;
(c) if the employer is a participant in the system, completing an authorization form and sending the completed authorization form to a financial intermediary;
(d) determining from the authorization form whether payables and receivables are in balance;
(e) if the payables and receivables are in balance, setting up a consumer account;
(f) forwarding the authorization to the employer; and
(g) setting up employee payroll deductions.

10. The method of claim 9, wherein, if it determined in step (b) that the employer is not a participant in the program, the method further includes:
determining whether the employer is willing to participate in the payment system and setting up a template for payroll deduction and funds transfer.

11. The method of claim 9, wherein, if is determined in step (d) that the payables and receivables are not in balance, the method further includes:
contacting the consumer to resolve payables and receivables issues.
